(19) United States
(12) Patent Application Publication
(10) Pub. No.: US 2026/0037377 A1
(43) Pub. Date: Feb. 5, 2026

(54) CONTROL METHOD OF FLASH MEMORY CONTROLLER FOR EFFICIENT DECODING

(71) Applicant: Silicon Motion, Inc., Hsinchu County (TW)

(72) Inventors: Mao-Ruei Li, Hsinchu City (TW); Duen-Yih Teng, Hsinchu County (TW); Shiuan-Hao Kuo, Hsinchu County (TW)

(73) Assignee: Silicon Motion, Inc., Hsinchu County (TW)

(21) Appl. No.: 19/096,746

(22) Filed: Apr. 1, 2025

Related U.S. Application Data
(60) Provisional application No. 63/678,506, filed on Aug. 1, 2024.

(51) Int. Cl. G06F 11/10

(52) U.S. Cl. CPC G06F 11/1068; G06F 11/1012

(57) ABSTRACT

The present invention provides a control method of a flash memory controller, which include steps of: receiving multiple data from a host device; encoding the multiple data to generate multiple codewords, respectively, wherein each of the multiple codewords comprises corresponding data and parity; writing the multiple codewords into a page of a block of a flash memory module; receiving a read command from the host device, wherein the read command requires the multiple codewords stored in the page; reading the multiple codewords from the page; sequentially decoding the multiple codewords to generate a decoding result; and in response to the decoding result indicating that at least one of the multiple codewords fails to be successfully decoded, using information of the successfully decoded codeword(s) to decode unsuccessfully decoded codeword(s).

### CROSS REFERENCE TO RELATED APPLICATIONS

This application claims the benefit of U.S. Provisional Application No. 63/678,506, filed on Aug. 1, 2024. The content of the application is incorporated herein by reference.

### BACKGROUND OF THE INVENTION

### 1. Field of the Invention

The present invention relates to a flash memory controller.

### 2. Description of the Prior Art

With the development of Low-Density Parity-Check (LDPC) codes, an encoder in flash memory controllers can encode data to generate error correction codes (ECC) with more bits, and can also encode data with more bits to generate the codeword with longer length, further enhancing their error correction capabilities. For example, commonly used encoders may include a 4-kilobyte (KB) LDPC encoder, which encodes 4 KB of data to generate the corresponding codeword. The latest 16 KB LDPC encoder, on the other hand, encodes 16 KB of data to generate a codeword with better error correction performance.

However, although the codewords generated by the 16 KB LDPC encoder offer better error correction capabilities during subsequent decoding, they have larger chip area and may encounter issues with decoding efficiency in certain scenarios. For example, the size of data from the host device may be smaller than 16 KB, such as 4 KB. In this case, the 16 KB LDPC encoder needs to encode four 4 KB data blocks to generate the corresponding 16 KB codeword and store this 16 KB codeword in a page of a block in the flash memory module. Then, if the host device sends a read request to read 4 KB data from the flash memory module, the decoder still needs to read the entire 16 KB codeword from the page and decode it, rather than decoding only the 4 KB codeword. As a result, the decoding efficiency is affected in such scenarios. This is especially problematic when the host device frequently sends read requests for just 4 KB of data, which significantly reduces the decoder's efficiency.

### SUMMARY OF THE INVENTION

It is therefore an objective of the present invention to provide a control method of the flash memory controller, which uses a collaborative codeword mechanism for encoding and decoding operation, to solve the above-mentioned problems.

According to one embodiment of the present invention, a control method of a flash memory controller comprises steps of: receiving multiple data from a host device; encoding the multiple data to generate multiple codewords, respectively, wherein each of the multiple codewords comprises corresponding data and parity; writing the multiple codewords into a page of a block of a flash memory module; receiving a read command from the host device, wherein the read command requires the multiple codewords stored in the page; reading the multiple codewords from the page; sequentially decoding the multiple codewords to generate a decoding result; and in response to the decoding result indicating that at least one of the multiple codewords fails to be successfully decoded, using information of the successfully decoded codeword(s) to decode unsuccessfully decoded codeword(s).

According to one embodiment of the present invention, a flash memory controller is disclosed. The flash memory controller comprises a read-only memory, a microprocessor, an encoded and a decoder, wherein the microprocessor, the encoder and the decoder are configured to perform steps of: receiving multiple data from a host device; encoding the multiple data to generate multiple codewords, respectively, wherein each of the multiple codewords comprises corresponding data and parity; writing the multiple codewords into a page of a block of a flash memory module; receiving a read command from the host device, wherein the read command requires the multiple codewords stored in the page; reading the multiple codewords from the page; sequentially decoding the multiple codewords to generate a decoding result; and in response to the decoding result indicating that at least one of the multiple codewords fails to be successfully decoded, using information of the successfully decoded codeword(s) to decode unsuccessfully decoded codeword(s).

According to one embodiment of the present invention, a memory device comprising a flash memory module and a flash memory controller configured to access the flash memory module is disclosed. The flash memory controller is configured to perform steps of: receiving multiple data from a host device; encoding the multiple data to generate multiple codewords, respectively, wherein each of the multiple codewords comprises corresponding data and parity; writing the multiple codewords into a page of a block of the flash memory module; receiving a read command from the host device, wherein the read command requires the multiple codewords stored in the page; reading the multiple codewords from the page; sequentially decoding the multiple codewords to generate a decoding result; and in response to the decoding result indicating that at least one of the multiple codewords fails to be successfully decoded, using information of the successfully decoded codeword(s) to decode unsuccessfully decoded codeword(s).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory device according to an embodiment of the present invention.

FIG. 2 is a diagram illustrating a block in the flash memory module according to one embodiment of the present invention.

FIG. 3 is a diagram illustrating the encoder 132 encodes data to generate codewords, and writes the codewords into the flash memory module according to one embodiment of the present invention.

FIG. 4 is a diagram illustrating a concept of the parity check matrix and parity generation matrix according to one embodiment of the present invention.

FIG. 5 is a flowchart of a control method of the flash memory controller 110 according to one embodiment of the present invention.

FIG. 6 is a flowchart of a control method of the flash memory controller 110 according to one embodiment of the present invention.

### DETAILED DESCRIPTION

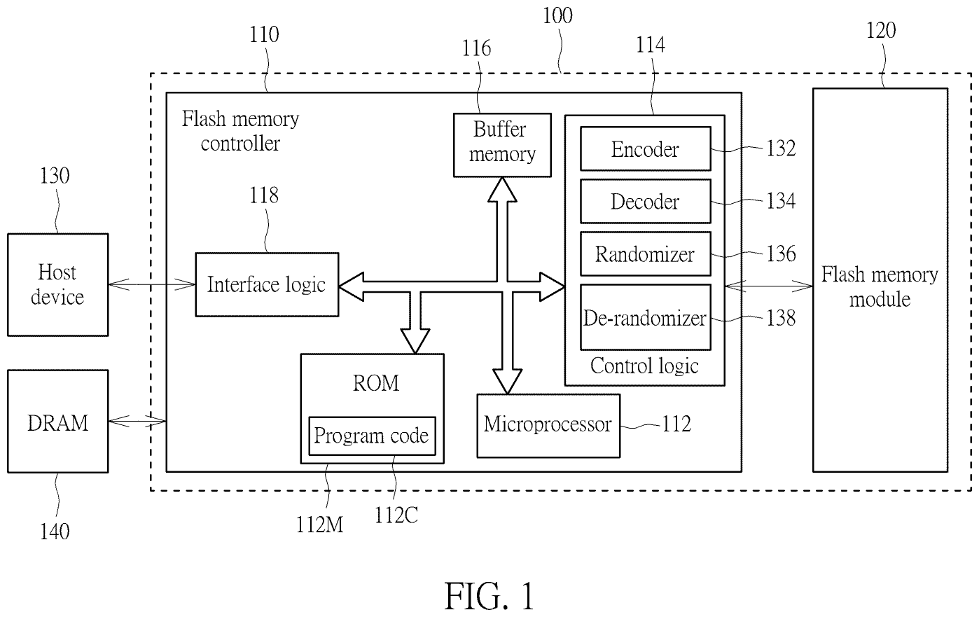

FIG. 1 is a diagram illustrating a memory device 100 according to an embodiment of the present invention. The memory device 100 includes a flash memory module 120 and a flash memory controller 110, wherein the flash memory controller 110 is arranged to access the flash memory module 120. The flash memory controller 110 includes a microprocessor 112, a read only memory (ROM) 112M, a control logic 114, a buffer memory 116 and an interface logic 118. The ROM 112M is arranged to store a program code 112C, and the microprocessor 112 is arranged to execute the program code 112C to control access of the flash memory module 120. The control logic 114 includes an encoder 132, a decoder 134, a randomizer 136 and a de-randomizer 138. The encoder 132 is arranged to encode data that is written into the flash memory module 120 to generate a corresponding parity (also known as an error correction code (ECC)), and the decoder 134 is arranged to decode data that is read from the flash memory module 120. The randomizer 136 is used to randomize the data written to the flash memory module 120, and the de-randomizer 138 is used to de-randomize the data read from the flash memory module 120.

In a general situation, the flash memory module 120 includes a plurality of flash memory chips, and each flash memory chip includes a plurality of blocks. A controller (e.g. the flash memory controller 110 that executes the program code 112C through the microprocessor 112) may copy, erase, and merge data for the flash memory module 120 with a block as a unit. In addition, a block can record a specific number of pages, wherein the controller (e.g. the flash memory controller 110 that executes the program code 112C through the microprocessor 112) may perform a data write operation upon the flash memory module 120 with a page as a unit. In other words, a block is the smallest erase unit in the flash memory module 120, and a page is the smallest write unit in the flash memory module 120.

In practice, the flash memory controller 110 that executes the program code 112C through the microprocessor 112 may utilize its own internal components to perform many control operations. For example, the flash memory controller 122 utilizes the control logic 114 to control access of the flash memory module 120 (more particularly, access at least one block or at least one page), utilizes the buffer memory 116 and/or a DRAM 140 to perform a required buffering operation, and utilizes the interface logic 118 to communicate with a host device 130.

In one embodiment, the memory device 100 may be a portable memory device such as a memory card which conforms to one of the SD/MMC, CF, MS and XD specifications, and the host device 130 is an electronic device able to be connected to the memory device 100, such as a cellphone, a laptop, a desktop computer, etc. In another embodiment, the memory device 100 can be a solid state drive (SSD) or an embedded storage device conforming to the universal flash storage (UFS) or embedded multi-media card (EMMC) specifications, and can be arranged in an electronic device. For example, the memory device 100 can be arranged in a cellphone, a watch, a portable medical testing device (e.g. a medical wristband), a laptop, or a desktop computer. In this case, the host device 130 can be a processor of the electronic device.

In this embodiment, the flash memory module 120 is a three-dimensional (3D) NAND-type flash memory, in which each block is composed of multiple word lines, multiple bit lines and multiple memory cells. Since the 3D NAND flash memory architecture is well known to those with ordinary knowledge in the art, no further explanation is given in the specification.

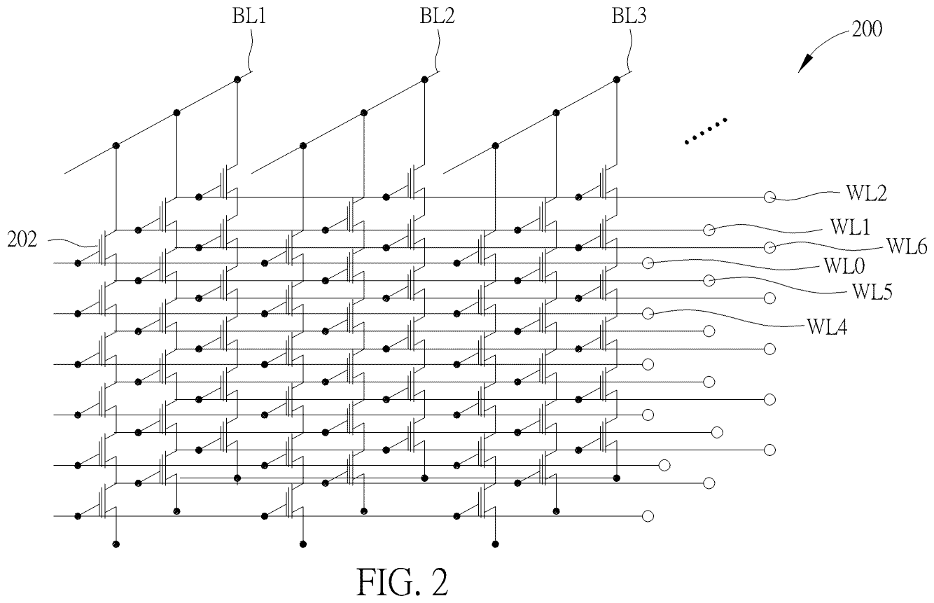

FIG. 2 is a diagram illustrating a block 200 in the flash memory module 120 according to one embodiment of the present invention, wherein the flash memory module 120 may be a 3D NAND-type flash memory. As shown in FIG. 2, the block 200 comprises multiple memory units (e.g. the floating-gate transistor 202 or other charge trap element), which form the 3D NAND-type flash memory mechanism via multiple bit lines (e.g. the bit lines BL1-BL3 shown in the figure, but the present invention is not limited thereto) and word lines (e.g. the word lines WL0-WL2, WL4-WL6 shown in the figure). Take the uppermost plane in in FIG. 2 as example, all floating-gate transistors on the word line WL0 form at least one page, all floating-gate transistors on the word line WL1 form at least another p floating-gate transistors on the word line WL2 further form yet at least another page, and so on. Further, due to different writing manners of the flash memory, the definition of the relationship between the word line WL0 and pages (i.e. logical pages) will also be different. Specifically, when writing with the single-level cell (SLC) technique, all floating-gate transistors on the word line WL0 are only corresponding to one single logical page (i.e., each memory unit stores only one bit, and the block 200 serves as a SLC block); when writing with the multi-level cells (MLC) technique, all floating-gate transistors on the word line WL0 are corresponding to two logical pages (i.e., each memory unit stores two bits, and the block 200 serves as a MLC block); when writing with the triple-level cell (TLC) technique, all floating-gate transistors on the word line WL0 are corresponding to three logical pages (i.e., each memory unit stores three bits, and the block 200 serves as a TLC block); and when writing with the quad-level cell (QLC) technique, all floating-gate transistors on the word line WL0 are corresponding to four logical pages (i.e., each memory unit stores four bits, and the block 200 serves as a QLC block). Since one skilled in the art should be readily to understand the structure of the 3D NAND-type flash memory and the relationship between word lines and pages, the detailed descriptions are omitted here for brevity.

The encoder 132 is a LDPC encoder, which encodes data from the host device 130 to generate at least one codeword (i.e., the encoded data), and store the codeword into the flash memory module 120. In this embodiment, in order to lower the chip area of the encoder 132, the encoder 132 has a collaborative codeword mechanism, which can use a lower-bit encoding operation to achieve functionality close to that of a higher-bit encoding operation. For example, the encoder 132 is a 4 KB encoder with smaller chip area, and the encoder 132 is configured to use the collaborative codeword mechanism to encode data to generate the data which has 16 KB encoding information. Therefore, when the flash memory controller 110 needs to read data from the flash memory module 120, the decoder 134, which is a 4 KB encoder with smaller chip area, can decode data with better error correction ability.

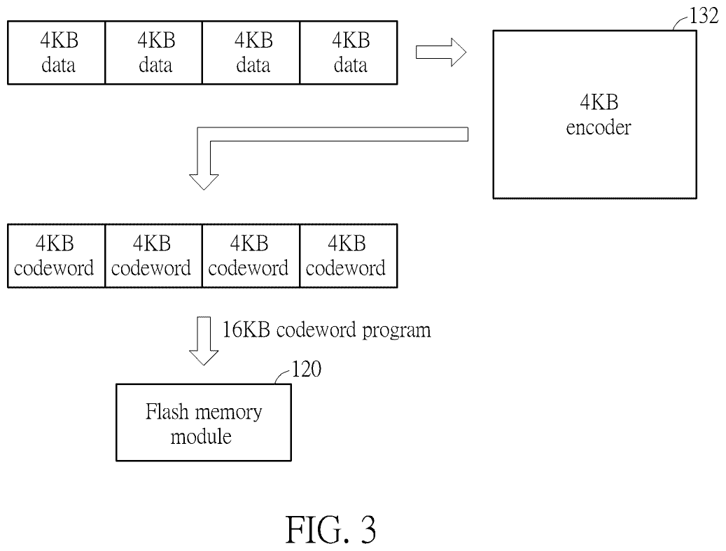

FIG. 3 is a diagram illustrating the encoder 132 encodes data to generate codewords, and writes the codewords into the flash memory module according to one embodiment of the present invention. As shown in FIG. 3, the host device 130 sends at least one write command, and the microprocessor 112 executes the at least one write command to read multiple 4 KB data from the host device 130. Then, the encoder 132 sequentially encodes the multiple 4 KB data to generate the corresponding codewords, respectively. In this embodiment, because the encoder 132 is a 4 KB encoder which encodes 4 KB data at a time, the encoder 132 uses specially designed parity check matrix and parity generation matrix to generate the corresponding codeword.

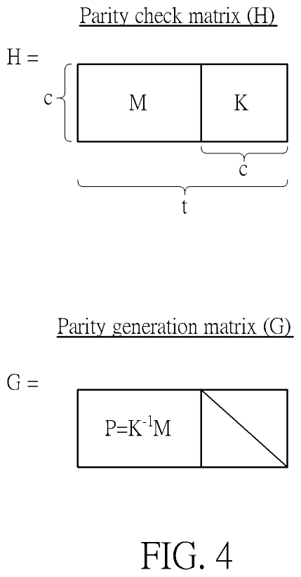

The encoder 132 has a parity check matrix and a parity generation matrix, wherein the parity generation matrix is used to multiply the 4 KB data to generate the corresponding codeword (the codeword comprises 4 KB data and corresponding parity (also named as ECC)); and the parity check matrix is used to check whether the codeword generated by the encoder 132 is correct. For example, after the encoder 132 encodes the 4 KB data to generate the corresponding codeword, the 4 KB data with the parity will be multiplied by the parity-check matrix, to generate a multiplication result. If the multiplication result is equal to “0”, it is determined that the encoding is correct; and if the multiplication result is not equal to “0”, it is determined that the encoding is incorrect. The parity generation matrix and the parity check matrix have a specific relationship. FIG. 4 is a diagram illustrating a concept of the parity check matrix and parity generation matrix according to one embodiment of the present invention. As shown in FIG. 4, the parity check matrix is a c*t matrix, and the parity check matrix can be divided into a left-side c*(t−c) matrix M and a right-side c*c matrix K. In order to find out the parity generation matrix corresponding to the parity check matrix, an inverse matrix K⁻¹ of the matrix K may be found out first. Afterwards, the inverse matrix K⁻¹ is multiplied by the matrix M to generate a matrix P, and a transpose matrix of the matrix P with an identity matrix can act as the parity generation matrix. In other words, the encoder 132 can multiply 4 KB data from the host device 130 by the transpose matrix of the matrix P with the identity matrix to obtain the codeword corresponding to the 4 KB data, and multiply the codeword by the parity check matrix to determine whether the encoding is correct.

In this embodiment, the parity generation matrix and the parity check matrix are designed so that the 4 KB codeword generated by the encoder 132 satisfies the checking of two parity check matrices corresponding to two different codeword lengths, wherein the 4 KB codeword comprises the 4 KB data and corresponding parity, so the actual size is a little more than 4 KB. Taking FIG. 3 as an example, each of the four 4 KB codewords is encoded by using a 4 KB parity generation matrix, so the multiplication result of the 4 KB codeword and the 4 KB parity check matrix is equal to “0”. In addition, the four 4 KB codewords can be regarded as a single 16 KB codeword, and a multiplication result of this 16 KB codeword and a 16 KB parity check matrix is also equal to “0”, wherein the 16 KB parity check matrix can be regarded as a virtual large matrix comprising four 4 KB parity check matrices on the diagonal and other zero matrices.

In the embodiment shown in FIG. 3, after four 4 KB codewords are generated successfully, the encoder 132 writes the four 4 KB codewords (ie., a single 16 KB codeword) into a page of a block within the flash memory module 120 (it is assumed that a size of each page is 16 KB).

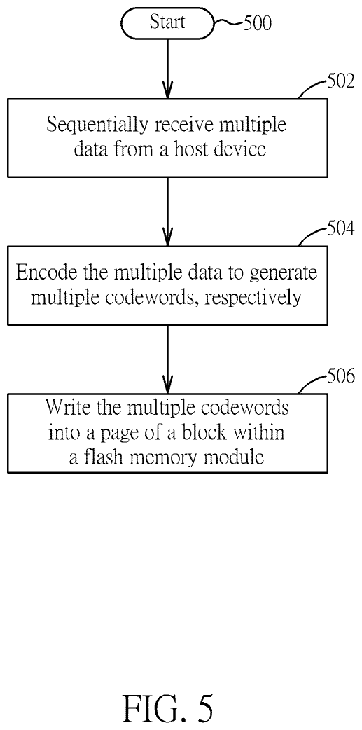

FIG. 5 is a flowchart of a control method of the flash memory controller 110 according to one embodiment of the present invention. Referring to the above embodiments together, the flow is described as follows.
Step 500: the flow starts.
Step 502: sequentially receive multiple data from a host device.
Step 504: encode the multiple data to generate multiple codewords, respectively.
Step 506: write the multiple codewords into a page of a block within a flash memory module.

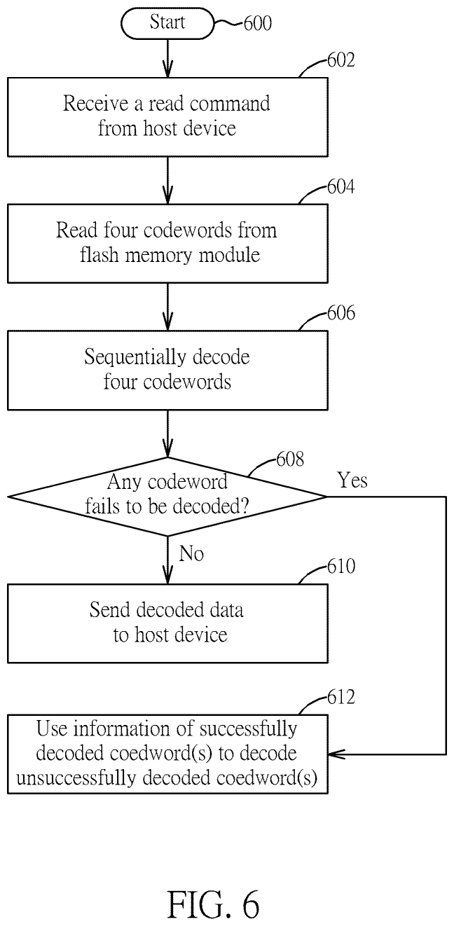

FIG. 6 is a flowchart of a control method of the flash memory controller 110 according to one embodiment of the present invention, wherein the flowchart of FIG. 6 follows the Step 506. In Step 600, the flow starts. In Step 602, the flash memory controller 110 receives a read command from the host device 130, wherein the read command requires the data corresponds to the four codewords (four 4 KB codewords) shown in FIG. 3, wherein the four codewords are stored in a single page of the flash memory module 120. In Step 604, in response to the read command, the flash memory controller 110 reads four 4 KB codewords from the page of the flash memory module 120. In Step 606, the decoder 134 sequentially decodes the four 4 KB codewords by using the above-mentioned 4 KB parity check matrix, to try to generate the decoded data. In Step 608, the decoder 134 determines if any one of the four 4 KB codewords fails to be successfully decoded, if yes, the flow enters Step 612; and if not, the flow enters Step 610.

In Step 610, because all of the 4 KB codewords are successfully decoded, the microprocessor 112 transmits the decoded data to the host device 130.

In Step 612, the decoder 134 uses the information of the successfully decoded codeword(s) to decode the unsuccessfully decoded codeword(s). For example, if only one of the four codewords fails to be successfully decoded, the decoder 134 uses information of the three successfully decoded codewords to decode the unsuccessfully decoded codeword. For another example, if two of the four codewords fail to be successfully decoded, the decoder 134 uses information of two successfully decoded codewords to decode the two unsuccessfully decoded codewords. For yet another example, if three of the four codewords fail to be successfully decoded, the decoder 134 uses information of one successfully decoded codeword to decode the three unsuccessfully decoded codewords.

Specifically, it is well known that the LDPC decoding method comprises updating check node information and bit node information, wherein the check node corresponds to rows of the parity check matrix, and the bit node corresponds to columns of the parity check matrix. In this embodiment, because each of the four 4 KB codewords corresponds to the 4 KB parity check matrix, and the entire 16 KB codeword comprising the four 4 KB codewords corresponds to the 16 KB parity check matrix, the decoder 134 can update the check node information corresponding to the 16 KB parity check matrix during decoding, and use the check node information corresponding to the 16 KB parity check matrix to decode the unsuccessfully decoded codewords.

In addition, if the all of the four 4 KB codewords cannot be successfully decoded, or the decoder 134 still fails to decode part of the codewords, the microprocessor 112 sends a message to the host device 130 to notify that the read fails.

Briefly summarized, by using the encoding method and decoding method of the present invention, the decoder 134 can use faster 4 KB decoding method to decode each codeword, and is able to achieve the 16 KB decoding performance. In addition, the decoder 134 has smaller chip area compared with the 16 KB decoder. Therefore, the flash memory controller 110 can have good decoding performance with smaller chip area.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a flash memory controller, comprising:
receiving multiple data from a host device;
encoding the multiple data to generate multiple codewords, respectively, wherein each of the multiple codewords comprises corresponding data and parity;
writing the multiple codewords into a page of a block of a flash memory module;
receiving a read command from the host device, wherein the read command requires the multiple codewords stored in the page;
reading the multiple codewords from the page;
sequentially decoding the multiple codewords to generate a decoding result; and
in response to the decoding result indicating that at least one of the multiple codewords fails to be successfully decoded, using information of the successfully decoded codeword(s) to decode unsuccessfully decoded codeword(s).

2. The control method of claim 1, wherein the step of encoding the multiple data to generate the multiple codewords, respectively comprises:
using a first parity generation matrix and a first parity check matrix to encode the multiple data to generate the multiple codewords, respectively;
wherein a multiplication result of each of the multiple codewords and the first parity check matrix is equal to zero, and multiplication result of the entire multiple codewords and a second parity check matrix is equal to zero, and the first parity check matrix and the second parity check matrix correspond to different codeword lengths.

3. The control method of claim 2, wherein the multiple data is four 4-kilobyte (KB) data, the first parity check matrix is a 4 KB parity check matrix, and the second parity check matrix is a 16 KB parity check matrix.

4. The control method of claim 2, wherein the step of in response to the decoding result indicating that the at least one of the multiple codewords fails to be successfully decoded, using the information of the successfully decoded codeword(s) to decode the unsuccessfully decoded codeword(s) comprises:
updating check node information corresponding to the second parity check matrix during decoding the multiple codewords; and
using the check node information corresponding to the second parity check matrix to decode the unsuccessfully decoded codeword(s).

5. The control method of claim 4, wherein the multiple data is four 4-kilobyte (KB) data, the first parity check matrix is a 4 KB parity check matrix, and the second parity check matrix is a 16 KB parity check matrix.

6. A flash memory controller, comprising:
a read-only memory, configured to store a program code;
a microprocessor, configured to execute the program code to control access of the flash memory module; and
an encoder and a decoder;
wherein the microprocessor, the encoder and the decoder are configured to perform steps of:
receiving multiple data from a host device;
encoding the multiple data to generate multiple codewords, respectively, wherein each of the multiple codewords comprises corresponding data and parity;
writing the multiple codewords into a page of a block of a flash memory module;
receiving a read command from the host device, wherein the read command requires the multiple codewords stored in the page;
reading the multiple codewords from the page;
sequentially decoding the multiple codewords to generate a decoding result; and
in response to the decoding result indicating that at least one of the multiple codewords fails to be successfully decoded, using information of the successfully decoded codeword(s) to decode unsuccessfully decoded codeword(s).

7. The flash memory controller of claim 6, wherein the step of encoding the multiple data to generate the multiple codewords, respectively comprises:
using a first parity generation matrix and a first parity check matrix to encode the multiple data to generate the multiple codewords, respectively;
wherein a multiplication result of each of the multiple codewords and the first parity check matrix is equal to zero, and multiplication result of the entire multiple codewords and a second parity check matrix is equal to zero, and the first parity check matrix and the second parity check matrix correspond to different codeword lengths.

8. The flash memory controller of claim 7, wherein the multiple data is four 4-kilobyte (KB) data, the first parity check matrix is a 4 KB parity check matrix, and the second parity check matrix is a 16 KB parity check matrix.

9. The flash memory controller of claim 7, wherein the step of in response to the decoding result indicating that the at least one of the multiple codewords fails to be successfully decoded, using the information of the successfully decoded codeword(s) to decode the unsuccessfully decoded codeword(s) comprises:
updating check node information corresponding to the second parity check matrix during decoding the multiple codewords; and
using the check node information corresponding to the second parity check matrix to decode the unsuccessfully decoded codeword(s).

10. The flash memory controller of claim 9, wherein the multiple data is four 4-kilobyte (KB) data, the first parity check matrix is a 4 KB parity check matrix, and the second parity check matrix is a 16 KB parity check matrix.

11. A memory device, comprising:
a flash memory module; and
a flash memory controller, configured to access the flash memory module;
wherein the flash memory controller is configured to perform steps of:
receiving multiple data from a host device;
encoding the multiple data to generate multiple codewords, respectively, wherein each of the multiple codewords comprises corresponding data and parity;
writing the multiple codewords into a page of a block of the flash memory module;
receiving a read command from the host device, wherein the read command requires the multiple codewords stored in the page;
reading the multiple codewords from the page;
sequentially decoding the multiple codewords to generate a decoding result; and
in response to the decoding result indicating that at least one of the multiple codewords fails to be successfully decoded, using information of the successfully decoded codeword(s) to decode unsuccessfully decoded codeword(s).

12. The memory device of claim 11, wherein the step of encoding the multiple data to generate the multiple codewords, respectively comprises:
using a first parity generation matrix and a first parity check matrix to encode the multiple data to generate the multiple codewords, respectively;
wherein a multiplication result of each of the multiple codewords and the first parity check matrix is equal to zero, and multiplication result of the entire multiple codewords and a second parity check matrix is equal to zero, and the first parity check matrix and the second parity check matrix correspond to different codeword lengths.

13. The memory device of claim 12, wherein the multiple data is four 4-kilobyte (KB) data, the first parity check matrix is a 4 KB parity check matrix, and the second parity check matrix is a 16 KB parity check matrix.

14. The memory device of claim 12, wherein the step of in response to the decoding result indicating that the at least one of the multiple codewords fails to be successfully decoded, using the information of the successfully decoded codeword(s) to decode the unsuccessfully decoded codeword(s) comprises:
updating check node information corresponding to the second parity check matrix during decoding the multiple codewords; and
using the check node information corresponding to the second parity check matrix to decode the unsuccessfully decoded codeword(s).

15. The memory device of claim 14, wherein the multiple data is four 4-kilobyte (KB) data, the first parity check matrix is a 4 KB parity check matrix, and the second parity check matrix is a 16 KB parity check matrix.
